(19) United States
(12) Patent Application Publication
(10) Pub. No.: US 2015/0344290 A1
(43) Pub. Date: Dec. 3, 2015

(54) PRECISION LIQUID DISPENSER

(71) Applicant: L. Molteni & C. dei Fratelli Alitti Societa' di Esercizio S.p.A., Scandicci (IT)

(72) Inventor: Roberto ANGELI, Scandicci (IT)

(21) Appl. No.: 14/339,838

(22) Filed: Jul. 24, 2014

(30) Foreign Application Priority Data
May 29, 2014 (IT) FI2014A000131

(51) Int. Cl. B67D 7/70; B67D 7/22; B67D 7/80; B67D 7/74; B67D 7/78

(52) U.S. Cl. CPC B67D 7/70; B67D 7/74; B67D 7/78; B67D 7/80; B67D 7/22

(57) ABSTRACT

A distributor of liquid methadone comprising a cooling device appropriately arranged in the hydraulic circuit is described.

### FIELD OF THE INVENTION

The present invention relates to a precision distributor for the controlled dispensing of liquid products, medicines in particular.

### STATE OF THE ART

As known, many medicines must be distributed under strictly controlled conditions and in very precise amounts; particular devices capable of dispensing extremely precise amounts of the necessary product in total safety have therefore been studied for this type of pharmaceuticals.

In particular, when the medicines are administered in liquid form (such as, for example, the case of methadone), said distributors allow to draw a predetermined amount of liquid from a feeding reservoir by means of a peristaltic type pump, which amount of liquid is then poured into a cup to be taken by the patient.

Furthermore, said distributors are generally controlled by a computer for identifying and managing the administrations required for the various patients.

As mentioned above, the distributors of this type must obviously guarantee maximum accuracy, this aspect being of particular concern in the administration of methadone, because of the importance and sensitivity of the treated cases and for the need to be able to certify the amounts of methadone which are actually supplied with precision.

Patent EP 1 1 65 010 (by the Applicant) describes a methadone dispenser provided with two peristaltic pumps, the hydraulic circuit of which comprises a recirculation sector of the treated liquid.

The recirculation allows to provide repeatable initial conditions identically at each dispensing operation and the circuit is additionally provided with an intermediate reservoir, different from the feeding bottle, which is used to bleed possible air bubbles and as a control point of the amount of liquid present in the circuit.

Notwithstanding the considerable advantage of the dispenser as described above with respect to those previously known, it also does not fully satisfy the precision needs, and it is thus an object of the present invention to make a distributor for liquid products, and in particular methadone, of even higher precision for dispensing and for calculating the treated amounts during operation.

### SUMMARY OF THE INVENTION

A distributor of liquid methadone comprising a cooling device appropriately arranged in the hydraulic circuit is described.

### BRIEF DESCRIPTION OF THE DRAWING

FIG. 1 diagrammatically illustrates a dispenser according to the invention.

FIGS. 2.1, 2.2, 2.3 and 2.4 show a flow chart which illustrates the various steps of the method according to the invention, in which p1 is a peristaltic pump, p2 is a piston pump, ev is a solenoid valve, s2 is an intermediate reservoir, m2 is the maximum level of s2. In particular, FIGS. 2.1 and 2.2 relate to the filling and keeping of the level in the intermediate reservoir (routine 01) and FIGS. 2.3 and 2.4 relate to the loading of the main pump circuit (routine 02).

### DETAILED DESCRIPTION OF THE INVENTION

The present invention allows to solve the aforesaid problems by virtue of a dispenser of the type described in the aforesaid patent EP 1 165 010 further comprising a cooling device.

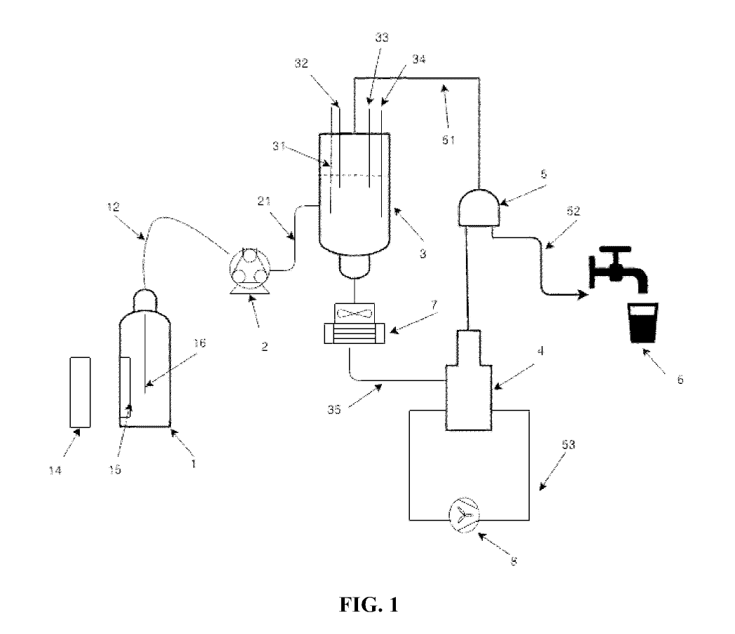

With reference to accompanying FIG. 1, a distributor according to the invention consists of:
a first pump 2 fed by an interchangeable bottle of liquid 1 by means of pipes 12, provided with a suction tube 16, which draws from the liquid contained in the bottle 1;
an intermediate reservoir 3 fed by means of pipes 21 by said first pump 2 and provided with one or more level sensors 31,33 and with a temperature probe 34;
a second high-accuracy pump 4, preferably of the type with one or more pistons fed by means of pipes 35 from said reservoir 3;
a liquid cooling system 7 arranged between said reservoir 3 and said pump 4;
a three-way valve 5 connected in input to the pump 4 and in output to the reservoir 3, by means of the pipe 51, and to the dispensed liquid collection vessel 6 by means of the pipe 52;
a microprocessor unit (not shown in figure) controlling and managing the pumps 2,4 of the valve 5 and of the probes 31,34.

The bottle 1 may be provided with identification means which may be read by appropriate sensors 14, while the pump 2 is preferably a peristaltic pump.

In a preferred embodiment, said means 15 are preferably of the RFID radiofrequency type, according to a recognition system known in itself, while corresponding sensors 14 are fixed to the apparatus and connected to the control unit of the apparatus which verifies destination volumes and dispensing operations.

The temperature probe 34 manages the temperature compensation of the dispensed liquid thereby maximizing measurement accuracy. Compensation is by correction according to a density reference value calibration curve corrected to the production temperature of 20° C.

The purpose of the cooling device 7 is to facilitate keeping the temperature of the liquid in the neighborhood of the terminal calibration value (20° C.) thus reducing, in practice, the variations introduced by the density variations of the liquid according to temperature, and may additionally cool the liquid to increase its pleasantness.

For example, said device 7 may consist of a Peltier cell, and start operation only when required to increase measurement accuracy when ambient temperature is high.

Advantageously, the pump 4 is of the ceramic piston type actuated by a stepper motor and in which the amount of displaced liquid in each cycle, of known duration, is precisely known.

Preferably, the pump 4 is provided with a recirculation (rinse-gland) circuit 53, which works as a liquid seal (water and glycerol) and is managed by a micro-pump (8) for precluding the migration of the measured liquid beyond the parallel circuit, preventing it from reaching the rear part of the pump. This also reduces the probability of the piston seizing in the cylinder.

It is apparent that the part of the hydraulic circuit which comprises the reservoir 3, the solenoid valve 5, the cooling device 7 and the pump 4 constitutes a recirculation circuit in which the liquid may be circulated by means of the pump 4 and the three-way valve 5.

The implemented liquid recirculation and loading system allows to obtain the required measurement precision from the first dispensing operation without needing priming dispensing operations of the apparatus with respective dispersion of the liquid.

In operation, the peristaltic pump 2 sucks the liquid from the bottle 1 and sends it to the reservoir 3 to reach, and subsequently keep, an appropriate level, which is detected by the probes 31-33. If the level is sufficient, the pump 4 will start recirculating the liquid until the pipes are surely and completely filled.

At the first dispensing operation, the control unit opens the dispensing valve 5 (obviously closing the recirculation way) for the dispensing time of the required amount of liquid.

The pump 4 will run a predetermined number of cycles if pauses of use occur between two dispensing operations which could cause changes of the state of the liquid or deviations with respect to the predetermined conditions at start of dispensing.

In order to guarantee the exact repetition of each dispensing operation, the pump 4 is further provided with means for determining an initial “zero”, from which the measurement of the amount being dispensed starts. According to the invention, the pump 4 is thus “reset” at each dispensing operation and returned to a start of dispensing position.

The aforesaid means consist of an electromagnetic proximity sensor, which works as a reference of the stroke of the piston of the pump and controls the advancement of the stepper motor.

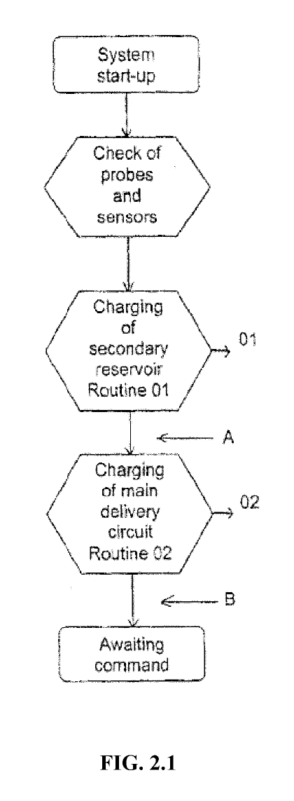

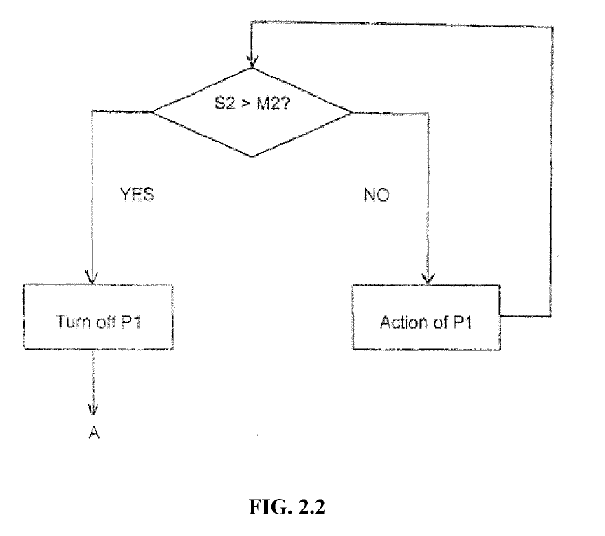

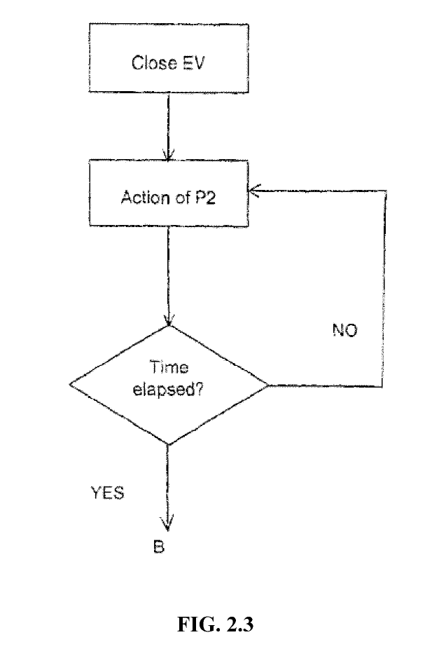

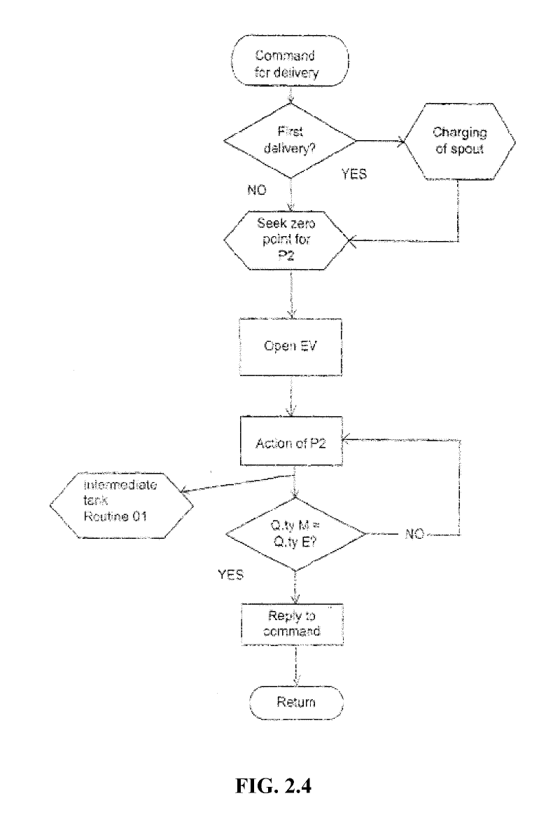

The steps of the dispensing process of the liquid are (see FIG. 2):
controlling the control probes and dispenser sensors;
loading an intermediate reservoir s2, for example by means of a peristaltic pump fed from a bottle containing the liquid to be dispensed, to a maximum level m2 (routine 01) detected by a level probe;
loading a recirculation circuit by a main pump p2 (routine 02), for example of the piston type, the circuit extending from the reservoir s2 to the dispensing valve ev;
in the case of a first dispensing control, loading of the spout of the bottle for feeding the liquid and searching for a resetting point of the pump; for subsequent dispensing operations with the same bottle, searching for the resetting point of the pump;
opening the dispensing valve ev and operating the pump p2;
executing routine 01 for controlling the level of the reservoir s2;
controlling the dispensed amount: if it corresponds to the expected amount, interrupting the dispensing and closing of the dispensing valve ev; and
waiting for a new dispensing control.

Furthermore, in case of prolonged inactivity between subsequent dispensing operations, the recirculation routine 02 is run to prevent possible changes to the state of the liquid (phase separations, formation of air bubbles etc.) present in the circuit of the pump 4.

1. A precision liquid dispenser consisting of:
a first pump (2) fed by an interchangeable bottle of liquid (1) by means of pipes (12), provided with a suction tube (16) which draws from the liquid contained in the bottle;
an intermediate reservoir (3) fed by means of pipes (21) by said first pump (2) and provided with one or more level sensors (31, 33) and with a temperature probe (34);
a second high-accuracy pump (4), preferably of the type with one or more pistons fed by means of pipes (35) from said reservoir (3);
a three-way valve (5) connected in input to the pump (4) and in output to the reservoir (3), by means of the pipe (51), and to the dispensed liquid collection vessel (6) by means of the pipe (52); characterized in that:
a liquid cooling system (7) is arranged between said reservoir (3) and said pump (4).

2. A dispenser according to claim 1, characterized in that the part of the hydraulic circuit comprised between the reservoir (3) and the solenoid valve (5) constitutes a recirculation circuit in which the liquid may be circulated by the pump (4) and the three-way valve (5).

3. A dispenser according to claim 2, characterized in that the pump (4) is of the ceramic type, with one or more pistons, actuated by a stepper motor and is provided with own recirculation circuit (53) (rinse-gland), which serves as a liquid seal (water and glycerol) and is managed by a micro-pump (8).

4. A dispenser according to claim 1, characterized in that it comprises means for searching for a starting zero point of each dispensing of the pump (4).

5. A dispenser according to claim 4, characterized in that said means consist of a proximity sensor able to detect the position of the pistons of the pump and control the advancement of the stepper motor.

6. A dispenser according to claim 1, characterized in that it comprises means (14) for identifying the bottle of liquid used.

7. A dispenser according to claim 6, characterized in that said means are RFID sensors or in all cases means suited to identify the dispensed product lots.

8. A dispenser according to claim 1, wherein said temperature probe (34) manages the temperature compensation of the dispensed liquid, thereby maximizing measurement accuracy.

9. A dispenser according to claim 2, characterized in that the implemented recirculation and loading system reaches, already in the first dispensing operation, the required measurement accuracy, without the need for triggering dispensing operations of the apparatus.
